(19) United States
(12) Patent Application Publication
(10) Pub. No.: US 2003/0212610 A1
(43) Pub. Date: Nov. 13, 2003

(54) System and method for specification and exchange management

(76) Inventors: Christopher A. Duffy, Olathe, KS (US); D. Kelly Holbrook, Kansas City, MO (US); Andrew H. Johnson, Overland Park, KS (US); Gopichand Kalahasthy, Shawnee, KS (US); John Michael Stradinger, Shawnee, KS (US); Robert W. Tietz, Lenexa, KS (US); Steven Kim Mitchell, Parkville, MO (US); Steven G. Richardson, Kansas City, MO (US); James D. Ramsey, Columbus, OH (US)

Correspondence Address: LATHROP & GAGE LC, 2345 GRAND AVENUE, SUITE 2800, KANSAS CITY, MO, 64108, US

(21) Appl. No.: 10/458,777

(22) Filed: Jun. 6, 2003

Related U.S. Application Data
(62) Division of application No. 09/620,625, filed on Jul. 20, 2000.
(60) Provisional application No. 60/184,920, filed on Feb. 25, 2000.

(51) Int. Cl. G06F 17/60

(52) U.S. Cl. 705/26

(57) ABSTRACT

A system and method for specification and exchange management includes a specification application, an exchange application, a source application, and an optional enterprise application. The specification application enables a user to create, modify, and retire specifications for items having standard terminology in a standard format. The exchange application enables a user to perform a transaction for generating a request for quote/request for proposal to designated suppliers for an item, receiving supply proposals in response to the requests, and forming a contract to supply of the items. The source application exchanges content between the specification application and the exchange application. The enterprise application communicates with user applications for users of the system and transmits content to and from the user and the specification application and the exchange application.

### RELATED APPLICATIONS

This application is a divisional of U.S. patent application Ser. No. 09/620,625, filed Jul. 20, 2000, and entitled System and Method for Specification and Exchange Management, which claims priority benefit to U.S. Provisional Application No. 60/184,920, filed Feb. 25, 2000, and entitled Method & System for Managing Packaging Operation, all of which are incorporated fully herein by reference. This application relates to co-pending, co-filed divisional U.S. Patent Application entitled System and Method for Specification and Exchange Management, internal docket number 410646, and assigned to the same assignee as this application.

### FIELD OF THE INVENTION

The present invention is related to the field of managing specifications for inputs into a manufacturing or selling process and the exchange of inputs.

### BACKGROUND OF THE INVENTION

Packaging, materials, and product identification items (collectively, packaging) are production goods that require custom engineering and intensive graphic design, involve printing technology, and frequently are used together. Many companies purchase all three products, and many raw material suppliers, distributors, and converters serve all three industries.

In the packaging industry, current sourcing processes are cumbersome and lengthy. There are inadequate means of creating, maintaining, aggregating, and communicating specifications for packaging, raw materials, ingredients, finished goods, and/or other inputs (hereafter, inputs). Further difficulties arise due to a lack of common industry terminology. To compensate for incomplete and inaccurate specifications, suppliers add a safety factor to their pricing to account for manufacturing errors.

In addition, there is a trend toward rapid and frequent changes in package graphics and products in packaged goods companies. This trend, in combination with the inadequate means for creating and communicating consistent specifications, increases the need for an effective specification management system.

Significant communications and logistics are required between a supplier and a buyer to produce and deliver packaging, products, and/or services in a timely and cost effective manner and with a high degree of quality. These communications and logistics also must occur within a supplier organization and a buyer organization to ensure that all members of the organization, including engineers, plant personnel, managers, marketing people, and sales people, have access to current information and designs and to the same information and designs. A breakdown in any of these communications and logistics can result in a buyer not receiving the requested packaging, products, or services or not receiving the packaging, products, or services in the time or manner requested. Currently, these communications and logistics are performed using manual processes requiring significant resources and time.

Thus, a system is needed to facilitate creating, maintaining, and aggregating specifications for inputs, such as packaging, ingredients, and raw materials, and to generate information common to all parties. A system is needed to facilitate efficient communication and interaction between buyers and suppliers of inputs and to enable suppliers and buyers to transact business in an efficient and cost efficient manner.

### SUMMARY OF THE INVENTION

The present invention is directed to a system for a system for managing a specification comprising a specification application comprising a data warehouse having a specification template and configured to generate the specification template with standard terminology and to receive and process specification content to create the specification. The system further comprises an exchange application configured to generate a request template for an item, to receive and process exchange content to create the request, and to transmit the request with the specification.

The present invention also is directed to a system for managing an input. The system comprises a specification application comprising a data warehouse having a specification template and configured to generate the specification template with standard terminology. The system also comprises a specification management module comprising an item definition of an item and configured to receive content to create a specification for an item, to manage storage of the content, and to manage real-time access to the specification.

Further, the present invention is directed to a system for managing a transaction. The system has a sourcing module configured to process information from a request with profile information to select at least one designated supplier to which the request can be transmitted and to generate an identification of the designated supplier. The system also has a procurement module configured to manage transaction content for the transaction after a contract is awarded.

Further yet, the present invention is directed to a method for managing an item. The method comprises connecting to a specification application and generating a template having a standard format and standard terminology for a specification for the item from the specification application. The method includes receiving content for the specification at the specification application and generating from the specification application the specification for the item using the content.

Also, the present invention is directed to a method for managing a transaction. The method comprises receiving profile information, receiving content for a request to generate the request, and receiving a buyer criteria. The method includes comparing profile information to the buyer criteria to determine if the profile information meets the buyer criteria. An identification of a user having profile information matching the buyer criteria is determined, and the identification of the user is transmitted. The request is transmitted with the content with an address identifying the user.

### BRIEF DESCRIPTION OF THE DRAWINGS

FIG. 1 is a block diagram of a management system in accordance with an embodiment of the present invention.

FIG. 2 is a block diagram of another management system in accordance with an embodiment of the present invention.

FIG. 3 is a block diagram of a specification system in accordance with an embodiment of the present invention.

FIG. 4 is a block diagram of an exchange system in accordance with an embodiment of the present invention.

FIG. 5 is a block diagram of another management system in accordance with an embodiment of the present invention.

FIG. 6 is a block diagram of a management system having an expanded specification and exchange system in accordance with an embodiment of the present invention.

FIG. 7 is a block diagram of user interface components used in conjunction with a management system in accordance with an embodiment of the present invention.

FIG. 8 is a block diagram of templates used in conjunction with a management system in accordance with an embodiment of the present invention.

### DETAILED DESCRIPTION

Specifications are descriptions or documents that detail parameters for dimensional, aesthetic, functional, and/or performance characteristics of each component of a package, a packaging system, a product, a finished product, a raw material, an ingredient, and another input. Specifications also may detail how individual characteristics are measured, identify packaging defects, and identify causes for the defects. The specifications can include parameters, such as units of measurement, finishing attributes, materials and treatments used to manufacture the item, color specifications, coatings, printing processes, ink types used for printing, item style, and/or the final usage of the packaging.

The management system of the present invention organizes, aggregates, and standardizes specification information and provides collaborative design tools, common defect and inspection terminology and metrics, manufacturing processes, distribution processes, and supplier management functionality for collaborative design, selling, purchasing, and other transactions. Because of the commonality of the management system, all users, both internal and external to a supplier or a buyer, can view and use the same information and metrics. Since the management system reduces or eliminates the occurrence of inaccurate or missing data, significant costs associated therewith are reduced.

The management system of the present invention enables all users of the system to enter, modify, retire, and track specifications for packaging, materials, and/or product identification (hereafter, packaging), finished products, raw materials, ingredients, services, and/or other inputs into a product or process (hereafter inputs). The management system ensures that all users simultaneously have real-time information for specifications of packaging and for requests, proposals, orders, and transfers of packaging.

The management system of the present invention provides a common exchange through which inputs automatically and electronically can be sourced and procured. The exchange enables suppliers to sell their products as inputs to existing buyers or new buyers.

Transactions occur when buyers populate a request for quote (RFQ) and/or a request for proposal (RFP) with information to identify required inputs, such as packaging or products. The management system can be configured to dynamically filter qualified suppliers based upon profile information entered by the suppliers or enable a buyer to search for qualified suppliers. Buyers can view qualified supplier profile information and send their RFQ/RFP to all qualified suppliers, a limited number of selected suppliers, or a single supplier.

The management system can be configured to electronically aggregate the responses to the RFQ/RFPs into easy to evaluate virtual matrices. Buyers then can review the responses, select quotes, and send electronic purchase orders to the selected supplier.

The selected supplier can review the purchase order and send an electronic acknowledgment accepting the order. The management system tracks the shipment of the order, and an electronic invoice can be issued to the buyer once the packaging has been shipped. In some instances, the management system will have a virtual showroom in which a supplier can display inputs, such as packaging, products, capabilities, and facilities.

These transactions are facilitated by the management system and save significant time and cost for buyers attempting to obtain items and suppliers attempting to provide items. This results in increased savings and potential sales for buyers and suppliers, respectively, at a reduced time and cost investment. Moreover, the buyers have a greater ability to locate acceptable suppliers, and the suppliers have a greater ability to receive and fill orders.

The transactions occur in real-time. Thus, there is not a large delay between the time items are needed and the time an order for those items can be filled. This helps all users manage their inventory in a more practical and up-to-date manner.

The management system enables all users simultaneously to track input shipments to and from all locations from the time a request for information (RFI) or an RFQ/RFP is issued, through their supply responses and potential order, and through delivery of the inputs. The management system generates quality of service (QOS) information for users based on tracking procurement and sourcing of inputs.

The management system enables users to track over time and allocate for the present or the future costs, costs to the industry, past logistics, future logistics, past inventory and input usage, and future inventory needs based upon past usage. Moreover, because members of a supplier organization and members of a buyer organization simultaneously can generate and view specifications for inputs and changes to those specifications in real-time, miscommunications and occurrences of wrongly manufactured inputs, such as packaging having printing, are reduced.

The management system generates templates in which users enter information for specifications. The templates generate drop down boxes and require all users, whether suppliers or buyers, to use the same standard terminology having universally defined terms to describe the input and the specifications of the input. Using standard terminology helps reduce miscommunications between buyers and suppliers who may otherwise attach different definitions to terminology or use terminology unfamiliar to another party.

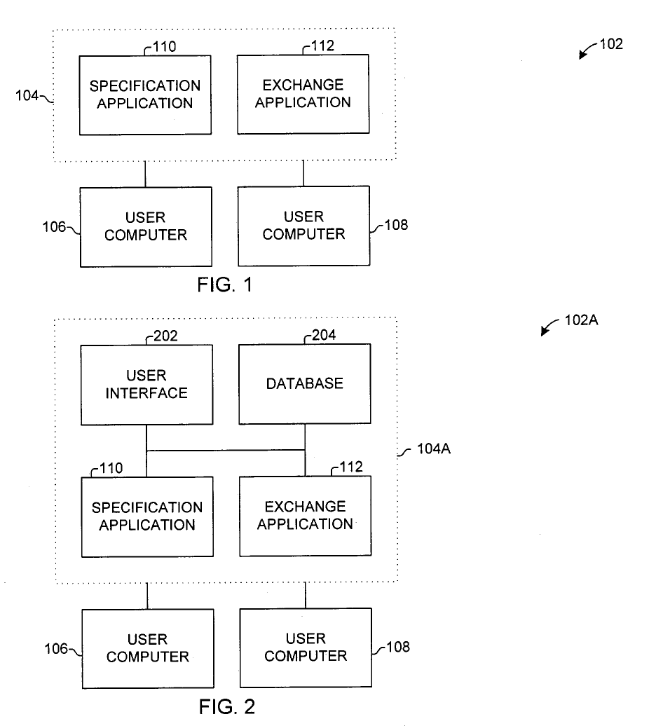

FIG. 1 depicts an exemplary embodiment of a management system of the present invention. The management system 102 operates to manage specification information and/or exchange information (hereafter, content) and to facilitate electronic transactions between buyers and suppliers. The management system of 102 of FIG. 1 comprises a specification and exchange system (SES) 104, a user computer 106, and a user computer 108. The term “request” shall be deemed to mean an RFI, an RFQ, and/or an RFP. The term “package” or “packaging” as used herein means packages, materials, and/or product identification items. The term “package” or “packaging” shall be deemed to include packages, products, goods, and/or services, whether or not one or more of those terms expressly are used together. In addition, the terms “item” and “input” alternately shall be deemed to include packaging, products, goods, finished products, raw materials, ingredients, and/or other inputs into a manufacturing process and/or services, whether or not one or more of those terms expressly are used together. Moreover, although the terms “packaging”, “product”, or “component”, for example, may be used in conjunction with an identification of subject matter or functionality, it will be appreciated that those terms are exemplary, and any input may be used in conjunction with that subject matter or functionality.

The SES 104 enables one or more users to generate, modify, and view specifications for inputs, such as packaging and products, in real-time and with other users. The SES 104 also enables a user to generate transactions, such as RFIs, RFQs, RFPs, supply proposals, purchase orders, invoices, and money transfers, in real-time with one or more other users. The SES 104 of FIG. 1 comprises a specification application 110 and an exchange application 112.

The specification application 110 comprises a data warehouse of specifications. The data warehouse includes one or more detailed physical characteristics, performance characteristics, material requirements, finished product shipping specifications, inbound shipping specifications, graphic images, printing specifications, technical drawings, historical archives, specification status, approved suppliers, approved manufacturing locations, general specifications, quality standards, defects, supplier performance, manufacturing inputs, raw material specifications, and/or process specifications. The specification application 110 stores and retrieves any documentation generated in the life of the specification, including memos, legal documents, correspondence, and notes on experimentation.

The specification application 110 enables users of the user computers 106 and 108 to design specifications using standard terminology and templates defined in the system. The specification application 110 describes terms and data in a universal manner for all users of the user computers 106 and 108. For example, users of the user computers 106 and 108 may include suppliers of packaging and buyers that obtain the packaging. Buyers are defined as entities that distribute products to consumers. Buyers are entities that purchase an input with the intention of selling it in a modified or unmodified form. Products are items used or consumed by a consumer, such as pallets, corrugated containers, or shampoo that is placed in a container. Brands are the design, graphics, or other features that identify a product and make the product recognizable by a consumer.

The specification application 110 operates to generate drawings of inputs, including products and packaging, such as CAD drawings or computer aided manufacture (CAM) drawings, or to import drawings of inputs, including products and packaging. For example, the specification application 110 can be used to design a drawing of a package, such as a pallet or a corrugated container. The designer or another user then can drill down to or view different components of the package. That is, the user can select a component of the package on the drawing, and a new screen is generated depicting the component in greater detail. The user can design and view multiple levels of components.

In addition, the specification management system 110 operates to generate images, such as three-dimensional (3D) images, of products, packaging, or other inputs, or to import images of products, packaging, or other inputs. The images enable a user to visualize the product, package, or other input while it is being designed or after it is designed.

The specification application 110 also operates to store and generate documents, such as correspondence, and identifications of specifications and parameters of specifications. The specification application 110 comprises templates for generating correspondence, RFIs, RFQs, RFPs, contracts, and other documents.

The specification application 110 retains a history of all changes to a specification, including the date and time the specification was changed, the reason for the change, the specific change made to a component, a component parameter, a component attribute/detail, or other characteristic of a package, who made the change, and/or which images, drawings, or documents were changed. The change history can be viewed at any time.

The specification application 110 has a search engine that enables a user 106 or 108 to locate content. For example, the search engine can be used to search for specifications by user, brand, product, company, component, specification parameter, or code, such as a UPC code, a general specification number, a component number, and other codes that are used to uniquely identify an item.

The exchange application 112 automates the sourcing and procurement of inputs, such as packaging. The exchange application 112 is used to generate RFIs, generate RFQs, generate RFPs, generate supply proposals, place orders, generate invoices, generate receipts, monitor and track shipments, and monitor and track inventory.

The exchange system 112 operates to filter qualified users of the user computers 106 and 108 that intend to supply inputs, such as packaging, with qualified users of user computers that intend to procure inputs, based on profiles, quality of service (QOS) requirements, and attributes selected by the procuring user. Profiles include information of a company, an entity, packaging, products, and/or capacity and other information.

The user computers 106 and 108 are any computer or processor that enables entry of information, generates information, and/or communicates with the SES 104. The user computers 106 and 108 may have input devices, such as a keyboard or a mouse, hand held remote computers, scanning devices, output devices, such as a monitor and/or a printer, a hard drive or other data storage device, a compact disk read only memory (CD ROM), a digital versatile disk (DVD) drive, and/or a modem, an ethernet card, or another network device. In some embodiments, the user computers 106 and 108 include touch screens configured to display a user interface in one of multiple languages and to enable selection of items and processes by touching the screen.

The user computers 106 and 108 communicate with the SES 104. Communications between the user computers 106 and 108 and the SES 104 can be provided over a connection, such as a digital or analog wireless or wireline connection, using a web-based communication protocol, such as hypertext transfer protocol (HTTP). Preferably, the user computers 106 and 108 have a browser configured to access web-based pages. In some embodiments, the user computers 106 and 108 use the browser to connect to the SES 104 over an internet protocol (IP) connection. The IP connection can be an internet connection or an intranet connection. In some embodiments, the user computers 106 and 108 are configured to communicate content, such as specification information and/or exchange information, using a web-based structured data exchange protocol, such as eXtensible markup language (XML) or electronic data exchange (EDI).

The user computers 106 and 108 may have user applications, such as accounting modules and inventory management modules. The accounting modules can be configured to generate orders, fill orders, generate invoices, and pay invoices. The inventory management modules manage the inventory at the user's site. For example, an inventory management module for the user application might send a purchase order or generate a requirement to the user's accounting module to generate a purchase order. Examples of user applications include enterprise requirement planning (ERP) modules or materials requirement planning (MRP) modules. The ERP modules and the MRP modules identify to a user when inventory should be ordered and manages the order and payment for the inventory. Other user applications may be used.

Within some user application modules resides a bill of material (BOM) that identifies each component, part, ingredient, or other input that is used to create a product. Basic BOM information may include a part/component number, a description, an amount used for each product, and waste. The BOM is used by the ERP to calculate the components and amounts necessary to make a production schedule for products to be manufactured.

The BOM is updated with content from the management system 104. The update process is automated. Once an input, such as a package or component, is designed in the specification application 110 and the status of the input is changed from pending to approved, the content for the input automatically is exported from the management system 104 or imported to the user application via a connection, depending on the user application.

A user of the user computers 106 and 108 can be a supplier, a broker, a buyer, a potential buyer or potential supplier, an information provider, another goods or service provider, or any other entity communicating with the SES 104. A user may be a supplier in some instances and a buyer in other instances.

The users of the user computers 106 and 108 may be suppliers of packaging and products and/or suppliers of services. Thus, for example, a supplier may supply shipping services in addition to bags, corrugated containers, or other packaging. Likewise, a user of the user computer 106 or 108 may be a buyer consuming services or packaging. Thus, for example, a buyer may be a purchaser of shipping services in addition to a purchaser of packaging, such as bags or corrugated containers. Each user computer 106 and 108 can be one or more user computers or entities.

The management system 102 of FIG. 1 operates as follows. In a first example, the user computer 106 connects to the specification application 110 of the management system 104 via an intranet connection. The user of the user computer 106 uses the specification application 110 to generate a specification for an input, such as a bag.

In this example, the specification application 110 generates to the user computer 106 a template in which the user enters specification information. The template requires the user to enter product information, including style, description, product unit of measurement, dimensional tolerance, product length, product width, and product depth or gusset. The template also requires entry of material specification information including material layer quantity, the material to be used, the material description, the material gauge/caliper, and the treatment for the material. Also, the layer designation direction and the overall material gauge/caliper are to be entered.

In addition, material properties are required, including water vapor transmission rate, oxygen transmission rate, tensile strength, tear resistance, opacity, impact strength, coefficient of friction, burst strength, grease proofness, deadfold property, puncture resistance, and stiffness. Manufacturing performance characteristics also are described, including coefficient of friction, sealing temperature, and blocking. Moreover, finishing information is required, such as finishing attributes, standards to be used to qualify and/or finish the package, and final usage of the product in the package. Printing information can be specified, such as color specification, a list of colors, ink type, the print process to be used, and coatings to be used. The user can specify if equivalent materials can be used and add any additional information that would further clarify the product that will be sourced.

The above attributes then are used by the specification application 110 to generate a complete specification for a package. Technical drawings, such as computer-aided design (CAD) drawings, or other technical documents can be used in conjunction with the attributes to create the package. Images can be imported to the specification application 110 and associated with drawings and/or the specification, including the specification attributes, so that a complete view of the package can be seen. Optionally, the user of the user computer 106 can identify the steps necessary to manufacture the package.

Referring still to FIG. 1, in another example, the user of the user computer 106 is a buyer, and the user of the user computer 108 is a supplier. In this example, the user computers 106 and 108 both connect to the exchange application 112 of the SES 104 via an internet connection.

In this example, the buyer desires to procure corrugated containers. The supplier previously has entered exchange information in a profile that describes the type of goods the supplier can supply and other company and manufacturing information, such as annual sales, capital expenditures, manufacturing locations, number of employees, and certifications.

The buyer generates an RFQ and an RFP to the exchange application 112 using the templates provided by the SES 104. The exchange application 112 processes the exchange information and/or the specification information identified in the RFQ/RFP, compares that exchange information and/or that specification information to the profiles of suppliers, and designates one or more suppliers that match the RFQ/RFP requirements.

The exchange application 112 transmits the RFQ/RFP to the designated suppliers. The designated suppliers each review the RFQ/RFP and each respond with a supply proposal (alternately, proposal) that is generated to the exchange application 112.

The exchange application 112 captures the exchange information from the supply proposals and transmits the supply proposals to the buyer. The exchange information from the supply proposals, along with the exchange information from the RFQ/RFP, is saved in the exchange application 112.

In this example, the buyer accepts the terms identified in the supply proposal from the supplier using the user computer 108. The buyer generates a purchase order to the exchange application 112. The exchange application 112 captures the exchange information from the purchase order and transmits the purchase order to the selected supplier (i.e. the user of the user computer 108).

The selected supplier receives the purchase order and ships the requested goods to the buyer. Thereafter, the selected supplier generates an invoice and an advanced ship notice (ASN) to the exchange application 112. The exchange application 112 captures the exchange information from the invoice and the ASN and transmits the invoice and the ASN to the buyer. In this example, the exchange application 112 also generates a flag to the buyer requesting the buyer to pay the supplier via a money wire transfer.

When the buyer receives the goods, the buyer logs the receipt of the goods and transmits a communication to the exchange application 112 confirming receipt of the goods. The exchange application 112 then closes the ASN.

Simultaneously, the buyer's accounting system matches the shipping documents with the purchase order and the invoice. The buyer's accounting system flags the buyer to issue payment through a money wire transfer. The buyer's user application transmits the money wire transfer to the exchange application 112 for the supplier's designated bank account.

In this example, the exchange application 112 captures information from all communications transmitted between the buyer and the supplier. The exchange application 112 captures information for specific packaging required, specifications and attributes of the required packaging, the quantity of the packaging required, the terms identified in the contract or purchase order, the cost for the quantity of the packaging required, and the shipping terms of the packaging.

FIG. 2 depicts an exemplary embodiment of a management system 102A in which the SES 104A comprises a user interface 202 and a database 204, in addition to the specification application 110 and the exchange application 112. The user computers 106 and 108, the specification application 110, and the exchange application 112 are the same as those described in FIG. 1. It will be appreciated that the specification application 110 or the exchange application 112 may be eliminated from the SES 104A of FIG. 2, and the remaining application will operate with the user interface 202 and the database 204.

The user interface 202 generates content to be transmitted to the user computers 106 and 108. The user interface 202 also generates templates and information that enable users of a user computer 106 or 108 to enter content to be transmitted to the SES 104A. In addition, the user interface 202 generates web-based pages and other data that enable a user of a user computer 106 or 108 to search the content using a search criteria.

The user interface 202 transmits and receives the content using web-based pages and web-based data exchange protocols. Preferably, the user interface 202 transfers and receives information and signaling using HTML pages, dynamic HTML (DHTML) pages, and/or other web-based pages using the XML protocol, the EDI protocol, or another web-based data exchange protocol.

The database 204 communicates with the specification application 110 and/or the exchange application 112. The database 204 stores content and retrieves content to be transmitted to, or used by, the specification application 110 and/or the exchange application 112.

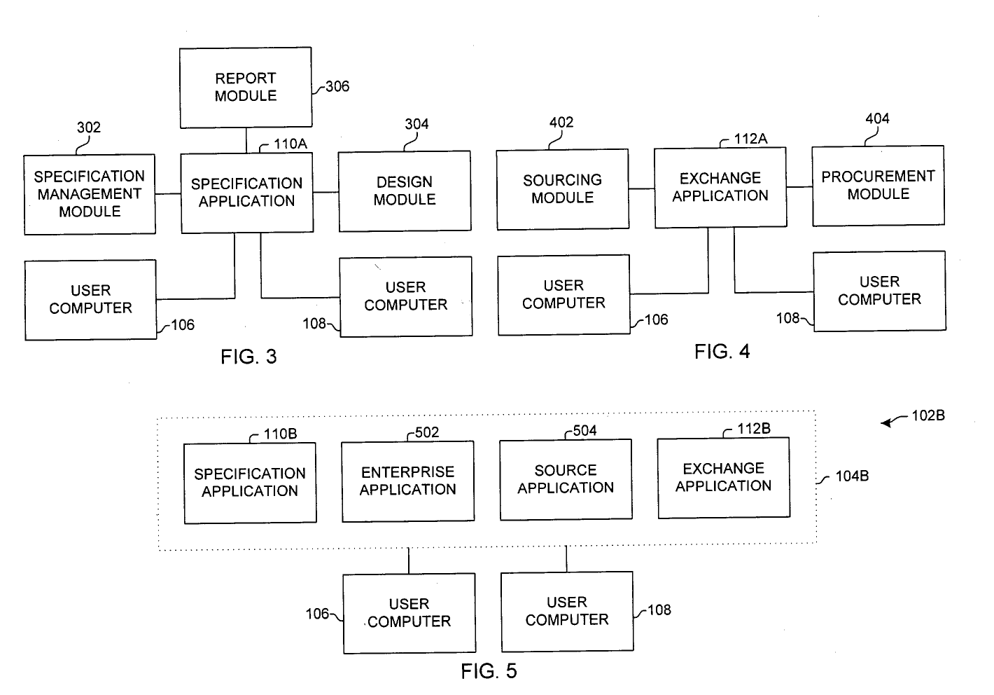

FIG. 3 depicts an exemplary embodiment of a specification application 110A with a specification management module 302, a design module 304, and an optional report module 306. The specification application 110A operates as the main communication point with the user computers 106 and 108 in this embodiment.

The specification management module 302 manages adding, modifying, and retiring specification information for the specification application 110A. The specification management module 302 contains the package, component, and other input definitions used to describe the packages, components, and other inputs, including components used to fully assemble the package. The definitions have standard terminology and a standard format so that all users use the same terms in the same format for all packages, components and inputs.

For example, the specification management module 302 defines a bag as a preformed, flexible container, generally enclosed on all but one side, which forms an opening that may or may not be sealed after filling. The bag may be made of any flexible material, independent layers of flexible materials, or laminated material.

In another example, corrugated is defined as a paperboard structure consisting of a central member (medium) that has been fluted on a corrugator and to which one or two flat sheets of linerboard have been glued to form single-faced, or single wall, corrugated board. Double wall is the combination of two mediums and three facings of linerboard.

As another example, a corrugated container is defined as a shipping container made of linerboard and a corrugating medium. Corrugated containers may be made in many styles, some of which are: 1) a regular slotted container (RSC) in which outer flaps meet and inner flaps do not meet unless length and width happen to be the same; 2) a center special slotted container (CSSC) in which inner flaps as well as outer flaps meet at the center although the length is greater than the width; 3) an overlap slotted container (OSC), which is similar to an RSC except that the outer flaps overlap a specified amount; 4) a full overlap slotted container (FOL) in which all flaps are the same length and outer flaps completely overlap not less than the inside width of the container minus a maximum of 25 millimeters (or 1 inch); 5) a gap-flap container in which outer flaps do not meet; 6) a five panel folder (FPF) in which a creased and slotted sheet is used for long articles and assembled after fitting; 7) a one piece folder (OPF) in which a one piece creased sheet has a corner cut out from the sheet; and 8) a telescopic design container in which a shipping container consists of two sections, one fitting over the other.

Other examples of defined components include a bag, a bottle, a can, a closure, a cornerboard, a crate, desiccant, an insert, foam, polyurethane, adhesives, hexacomb, hot melt adhesive, a label, a nail, a pallet, a reel, a slip sheet, a spacer, a staple, a static intercept (static dissipative), strapping, stretch wrap, tape, a tube, and a unit load. Other examples exist.

The specification management module 302 manages the access to, and storage of, all specification information, including drawings and images. In some embodiments, the specification management module 302 also manages access to, and storage of, all or a portion of exchange information. The specification management module 302 retains a history of all changes to any specification, including the time and date the specification was changed, the reason for the change, the specific change made to a component, a component parameter, a component attribute/detail, or other characteristic of a package, who made the change, and which images, drawings, or documents were changed.

The design module 304 comprises a collection of design tools used to perform on-line real-time collaboration for the design and development of packaging, products, and other inputs. The design module 304 is used to perform project management, workflow management, project monitoring, documentation, structural design, graphic design, and finite element analysis for packaging, its components, and other inputs.

The design module 304 is used to develop a full product, including the product itself, the brand for the product, and the commercialization of the product. For example, when a product is developed, the product itself, the package in which the product is actually sold to the consumer, images and graphics for the brand printed on the product package, and the manufacturing process with which the product and the package are made, and the distribution process in which the product and the package are distributed all are developed concurrently to make this product. Thus, the design module 304 is used to generate drawings and images of a product, product packages, and packages in which product packages are shipped.

The design module 304 uses design predictors and performance predictors. The design predictors are used to generate a recommendation of the size and the type of the package or other input to be manufactured. For example, when a package is being designed, the basic composition of the product, the anticipated volume of the product to be placed in the package, the weight of the product to be placed in the package, the distribution channel with which the package will be distributed, and the region to which the product will be distributed are input as design predictors for the design module 304. The design module 304 then will recommend the optimal size and type of the package to be constructed.

The performance predictors are used to determine the type of materials used with the package or other input when the package or other input is assembled and used for a product. Performance predictors may include the product volume and weight, the package in which the product is sold to the consumer, the package in which the product is shipped through distribution channels, an identification of the product itself, and specific requirements for that package. For example, if a product is to be shipped in a corrugated container, performance predictors will generate the type of material, such as a liner-medium-liner structure, to be placed around the product when the product is placed in the package.

Some products require specific environmental conditions to prevent damage to the product. The performance predictors will generate a recommendation for the type of package materials that are necessary to maintain the optimal environmental conditions.

The report module 306 enables a user to query and organize component specifications or any specification that is stored in the specification application 110A. Components may be aggregated for product lines, brands, sites, buyers, different companies, or other parameters. The report module 306 also generates reports identifying specific specification information in requested formats, such as specifications relating to a component, a product, a company, or a user. For example, all corrugated specifications may be queried and analyzed to facilitate the standardization of dimensions that will reduce the over all unit cost.

FIG. 4 depicts an exemplary embodiment of an exchange application 112A having a sourcing module 402 and a procurement module 404. The exchange application 112A with the sourcing module 402 and the procurement module 404 enables a user computer 106 to buy or supply packages (including products), services, or other inputs.

The sourcing module 402 is used to initiate and execute a supply program. The sourcing module 402 walks buyers through a sourcing program for strategic purposes and transactional purposes.

The sourcing module 402 helps a user determine how an input or a potential supplier fits strategically within the buyer's organization. Based upon information provided by the buyer to the sourcing module 402, the sourcing module generates recommendations about how a particular industry or a particular supplier should be approached and how purchasing and shipping can be more efficient and cost effective.

The sourcing module 402 also is used for transactional purposes to initiate a transaction through a stage when two parties make a contract for purchase and supply of one or more inputs. The sourcing module 402 includes RFI generators, RFQ generators, RFP generators, and a purchased items matrix to determine the sourcing method and dynamic filtering of suppliers based on buyer criteria and responses by suppliers and third parties. The buyer criteria can be defined using standard templates with standard terms, email and bulletin board capabilities for confidential and open communication between a buyer and a supplier during the sourcing process, supplier entered information such as prices and alternative structures, supply proposals, and analytical tools. The sourcing module 402 provides a message board and a messaging service so that buyers can comment on any supplier inquiry, suppliers can request clarification regarding specifics in the RFQ/RFP, and buyers and suppliers can communicate with each other.

For example, if a buyer receives bids from three potential suppliers, the sourcing module 402 can be configured to identify how much money can be saved over a period of time by using one or more of the suppliers. The sourcing module 402 also can be configured to group inputs by supplier or by the type of input and to compare the groupings to show how each input or group compares to the other inputs or groups.

The sourcing module 402 compares buyer criteria as specified in an RFI, an RFQ, and/or an RFP with other exchange information, such as company profiles and QOS profiles of potential suppliers. The sourcing module 402 then selects one or more suppliers based upon those factors. Alternately, the sourcing module 402 uses exchange information to match potential suppliers with buyers so that a buyer may select a supplier.

Thus, the sourcing module 402 can be configured to generate to a buyer a list of suppliers that meet the buyer's criteria or to forward the RFQ and the RFP to the suppliers that meet the buyer's criteria. In either case, the supplier or suppliers that meet the buyer criteria (alternately, user criteria) then generate a supply proposal which includes specific pricing, through the exchange application 112A to propose meeting the buyer's criteria and to propose pricing terms, shipping terms, and other contract terms.

The sourcing module 402 manages the exchange information identified in transactions between a buyer and a supplier, including content in RFIs, RFQs, RFPs, supply proposals, and contracts and retains the information for further use. The sourcing module 402 manages locating a supplier for a buyer based upon the buyer's needs.

The procurement module 404 manages all information related to the actual transactions after a contract is awarded. Examples of post-contract transactional information include master purchase orders (POs), release POs, Blanket POs, invoices, and ASNs.

The procurement module 404 manages the information identified in the transactions to track pricing of inputs, in the present and over time, and other logistical information, such as how inputs such as packaging, products, or other inputs are shipped from a supplier to a buyer, the quality of the shipped packaging, product, or other input, the time it takes to ship packaging, products, or other inputs from a supplier to a buyer, and the time involved from start to finish from the initial RFQ/RFP generated by a buyer to the point in time in which the buyer receives the packaging, product, or other input. The logistical information can be used to bring suppliers together with other suppliers to more effectively and efficiently transport packaging, products, or other inputs by combining shipments over one carrier, by determining an efficient time opening or timeframe in which the shipping can be made, and other logistics for the shipment and transport of packaging, products, and other inputs.

The procurement module 404 stores, monitors, and manages information generated from the purchase orders and invoices, monitors the purchase order information, shipping information from the supplier, shipment reception information from the buyer, invoices generated from the supplier, and money transfers so that the process from purchase order to payment is automated through the exchange application 112A. This exchange information is received through the exchange application 112A by a buyer or supplier and transmitted seamlessly in real-time to the appropriate buyer or supplier.

The procurement module 404 monitors and facilitates the movement of money between buyers and suppliers. The procurement module 404 monitors the movement of goods pursuant to a contract based on reviewing content transmitted between a buyer and a supplier via the SES 104C. For example, if a quantity of received goods is below the range of goods ordered, the procurement module 404 is used to determine if a short shipment is received by the buyer and the course of action to be taken.

The exchange application 112A of FIG. 4 operates as follows. All exchange information flows from a user computer 106 or 108 through the exchange application 112A and back to a user computer. Thus, in one example, an ERP or MRP module for a user computer 106, such as a buyer, transmits exchange information to the exchange application 112A in the form of an RFQ/RFP. The exchange application 112A, using the sourcing module 402, places the exchange information into a format that both the buyer and a potential supplier can readily view and identify. Another user of a user computer 106 or 108, such as a supplier, generates exchange information in the form of a supply proposal in response to the RFQ/RFP of the buyer. The exchange application 112A, using the sourcing module 402, places that exchange information in a format that both the buyer and the supplier can readily view and exchange.

Once the contract is awarded, a purchase order is generated from the buyer to the exchange application 112A. The exchange application 112A, using the procurement module 404, places the exchange information from the purchase order into a form that readily can be viewed and exchanged by the buyer and the supplier. After the goods are delivered by the supplier to the buyer, the supplier issues an invoice through the exchange application 112A to the buyer.

In one embodiment, funds are transferred from the buyer to the SES 104C after the packaging or other products are shipped. The SES 104C then transmits the money to the supplier once the buyer receives the packaging or other products. In another embodiment, money is wire transferred between the buyer and the supplier via the SES 104C. In this embodiment, once a purchase order is generated and the invoice is generated in response to providing the packaging or other products, the SES 104C triggers a flag that the wire transfer of the money should occur within a certain time frame.

Because the exchange application 112A uses templates from the start to finish process, both the buyer and the supplier have the same exchange information using the same terminology. This facilitates accurate sourcing from the supplier to the buyer. Moreover, because the exchange information is supplied in an electronic and automated fashion through the exchange application 112A using the sourcing module 402 and the procurement module 404, the exchange information is generated between the buyer and the supplier in real time, and the transfer of communications and packaging associated with the awarded contract occurs at a much expedited rate.

FIG. 5 depicts an exemplary embodiment of a management system 102B in which the SES 104B comprises an enterprise application 502 and a source application 504 in addition to the specification application 110B and the exchange application 112B. The specification application 110B and the exchange application 112B are the same as those described above unless noted below.

The enterprise application 502 operates as an interface between the user computers 106 and 108 and the specification application 110B and the exchange application 112B. The enterprise application 502 receives content from the user computers 106 and 108, places the content in a format that can be used by the specification application 110B and the exchange application 112B and any modules thereof, and generates content to the user computers 106 and 108 in a format that readily can be viewed and used by the users.

The enterprise application 502 operates as a conduit between the specification application 1101B and/or the exchange application 112B and the user computers 106 and 108 using a web-based data exchange protocol, such as the XML protocol. The web-based data exchange protocol identifies where content is located within communications transmitted between the SES 104B and the user computers 106 and 108. Because the location of the content is known, the enterprise application 502 can monitor the content and save selected pieces of the content for present or future use.

The enterprise application 502 may include middleware. Middleware is an interface that facilitates communication of information, such as content, between different applications or interfaces. The middleware operates to seamlessly transfer content between the user applications on the user computers 106 and 108 and the specification application 1101B and the exchange application 112B.

The source application 504 is an engine used for entering, searching, locating, retrieving, and/or transferring content. One or more of the functions may be eliminated.

The source application 504 transfers content between the specification application 110B and the exchange application 1121B. The source application 504 can be configured to map content from one location to another and to store content in one location or another. The source application 504 aggregates common package types across one or more divisions, companies, or entities for sourcing activities.

In addition, the source application 504 can be used by a user to enter content into an RFQ/RFP or another template or document. In some embodiments, a user can connect directly to the source application 504 to generate an RFQ/RFP, to generate a response proposal, to generate another document, or to perform a transaction. In other embodiments, a user can connect to the source application 504 through the enterprise application 502.

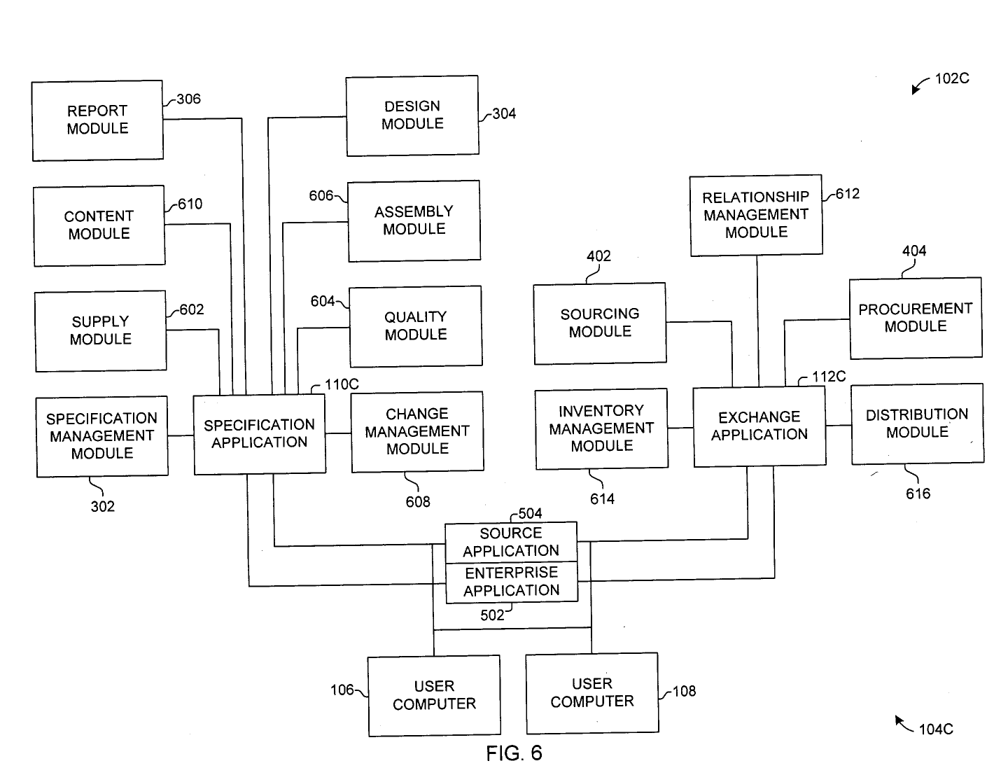

FIG. 6 depicts an exemplary embodiment of an expanded SES 104C. The specification application 110C of FIG. 6 further includes a supply module 602, a quality module 604, an assembly module 606, a change management module 608, a content module 610, the specification module 302, the design module 304, and the report module 306. The specification management module 302, the design module 304, and the report module 306 are the same as those described above. In the embodiment of FIG. 6, the user computers 106 and 108 can access the specification application 110C directly, via the enterprise application 502, and/or via the source application 504. In other embodiments, the user computers 106 and 108 can access the specification application 110C only directly, only via the enterprise application 502, or only via the source application 504.

The supply module 602 tracks supplier performance metrics, such as on-time delivery, the number and types of defects per unit of input, cost overruns, other factors increasing or decreasing costs for inputs under a specific contract and over a period of time, and whether contract terms are fulfilled as negotiated. The supply module 602 uses the supplier performance metrics to provide a QOS rating for each supplier. The QOS rating and the profiles of each supplier are used to match buyers to suppliers.

The quality module 604 identifies and tracks defects for inputs, such as packaging, generates and tracks inspection process and reports, and tracks the processes and timeline to create a resolution to any input defects. The quality module 604 specifies an acceptable level of quality, generates, in conjunction with the assembly module 606, a proper identification of an assembly of an input, evaluates inputs and components of inputs for defects, identifies potential causes of a defect, and identifies actions that can be taken to correct defects. The quality module 604 enables users to input and retrieve information on inputs, buyers, manufacturing, distribution, and suppliers.

The assembly module 606 identifies proper materials and components to be used for a package, or other input and the proper standardized procedures in which the components and materials are to be used to assemble a package or other input, including detailed instructions having drawings, images, and video. The assembly procedures also may be used to set up packaging displays, manufacturing processes, and intermediate packages. By using the standard procedures of the assembly module 606, packaging defects are prevented or reduced.

The change management module 608 archives a specification history, including changes to any specifications, drawings, and images. The specification changes include draft, pending, approved, active, and retired. The change management module 608 also detects potential errors in a change to a specification. Thus, the change management module 608 is used as a first line of approval or rejection to a change of a specification. Once a specification has been approved, the change management module 608 automatically activates the specification.

The content module 610 enables a user to change user interface content. For example, terms can be changed so that the terms are consistent with a company's terms. These terms are words in a specification, such as “depth” or “height” dimension. A user may want the term to be displayed as “height dimension” rather than “depth”. Preferably, the definitions to the terms cannot be changed, and the base meaning of the field that the term describes cannot be changed.

The exchange application 112C also has additional associated modules in the embodiment of FIG. 6. The exchange application 112C comprises a relationship management module 612, an inventory management module 614, a distribution module 616, a sourcing module 402, and a procurement module 404.

The relationship module 612 enables a buyer and a supplier to manage their respective goals against contract terms that are negotiated between the parties. These goals typically include on-time delivery, inventory level, inventory turns, quality, waste reduction, cost reduction, and other goals that are targeted toward achieving greater efficiencies and lower total costs. This relationship is facilitated through the use of company, brand, packaging, and component profiling and the use of standardized terminology and common formatting of exchange information.

The relationship management module 612 provides work flow management tools to manage a buyer and a supplier project to achieve their respective goals. For example, the relationship management module 612 is used to manage contract terms to determine who is doing what, where, how, and when. If, for example, a buyer desires to conclude a project, such as a shipment, on a specific date, the buyer enters that information into the contract.

In some instances, the relationship management module 612 operates in conjunction with the quality module 604. The relationship management module 612 may capture quality type information, such as on time shipments, from the quality module 604. The relationship management module 612 monitors how a purchase price has changed over a period of time to see if and how money may be saved by a buyer requesting packaging, products, services, or other inputs from a supplier.

The inventory management module 614 monitors content transmitted between a supplier and a buyer. For example, when a contract is negotiated and transmitted between a buyer and a supplier, the inventory management module 614 monitors and tracks payment terms, specific packaging items being transmitted as inventory, and the quantity being purchased.

The inventory management module 614 monitors contract terms, shipments, and other supplier metrics and forecasts costs and availability for future needs of buyers. The inventory management module 614 also tracks purchase orders and invoices. In this way, the inventory management module 614 can determine where inventory is located, such as whether the inventory is located at a supplier's site, in transit, or located at a buyer site. The inventory management module 614 makes this information available to buyers and suppliers.

In addition, the inventory management module 614 facilitates moving packaging and other input inventory from a supplier to a buyer and creating inventory at a supplier because the inventory management module is used to determine the inventory that requires replenishing and the inventory that requires moving. The inventory management module 614 checks all inventory for buyers and suppliers and how that inventory is moved.

The information collected by the inventory management module 614 is used to generate exception reports that identify items that should be ordered, items that are on order but for which the order should be delayed or stopped, quantities of items that should be changed, and items that are overstocked or under-stocked. The inventory management module 614 generates the same information to both buyers and suppliers so that each can see the same real time data.

The distribution module 616 uses the content identified by the inventory management module 614 and the other modules associated with the SES 104C to determine how an input that is to be supplied to and/or from a buyer can most efficiently and effectively be transported/shipped. The distribution module 616 determines how the packaging is to be shipped to the buyer and how the packaging is to be loaded on the shipment vehicle. For example, the distribution module 616 uses the content of the SES 104C to determine how to maximize loads on a truck or other vehicle to be shipped from one location to another. The distribution module 616 may determine that more than one supplier of packaging or another input can transport that packaging or input on the same truck or other vehicle to a particular location. This distribution module 616 enables buyers and suppliers to save transportation costs and to increase their efficiency for transportation.

The management system 102C of FIG. 6 operates as follows. In a first example, the user of the user computer 106 is a buyer, and the user of the user computer 108 is a supplier. The buyer and the supplier connect to the enterprise application 502 via an IP connection. The buyer's user computer 106, the supplier's user computer 108, and the enterprise application 502 transmit and receive content using the XML protocol in web-based pages.

In this example, specifications for packaging have been created. In addition, an RFI has been generated to multiple suppliers. The RFI requests information for the supplier's profile and capacity to produce and supply a variety of packaging items. The RFIs have been returned by the suppliers to the SES 104C and processed by the sourcing module 402.

In this example, the buyer desires to procure packaging for corrugated containers. In addition, the supplier desires to sell packaging for corrugated containers.

The buyer generates an RFQ and an RFP to the enterprise application 502 using templates provided by the SES 104C. The enterprise application 502 transfers the RFQ/RFP to the exchange application 112C.

The sourcing module 402 associated with the exchange application 112C processes the exchange information identified in the RFQ/RFP. The sourcing module 402 operates with the relationship module 612 to compare the exchange information from the RFQ/RFP to qualified supplier profiles and quality of service information pulled from the quality module 604.

The sourcing module 402 selects suppliers that can meet the required buyer criteria, including the required quality of service. These suppliers are referred to as designated suppliers. In this example, the exchange application 112C transmits the RFQ/RFP to the designated suppliers. However, in other embodiments, the exchange application 112C can generate the list of designated suppliers to the buyer and allow the buyer to select one or more of the designated suppliers to which the RFQ/RFP will be transmitted.

The RFQ/RFP is transmitted through the enterprise application 502 to the designated suppliers, including the supplier using the user computer 108. During the transfer, exchange information is transmitted to the specification application 110C through the enterprise application 502 for storage. In addition, some exchange information is saved by the sourcing module 402 2 for further usage.

The suppliers each respond to the RFQ/RFP with a supply proposal. The supply proposals are transmitted to the enterprise application 502 and passed to the exchange application 112C where content is captured from the supply proposals. The content is fed in real-time to the specification application 110C and saved. In other embodiments, the content is saved by the exchange application 112C in an associated database. The supply proposals are transmitted back through the enterprise application 502 and to the buyer.

The buyer selects the supplier using the user computer 108 to supply the required packaging. The selected supplier and the buyer negotiate terms and form a contract. The contract is generated between the buyer and the selected supplier through the enterprise application 502 and through the exchange application 112C. Exchange information is captured from the contract and saved by the procurement module 404 and the relationship management module 612.

The buyer generates a purchase order through the enterprise application 502 to the exchange application 112C. The procurement module 404 and the relationship management module 612 capture exchange information from the purchase order, including the packaging type, the quantity ordered, the cost, the shipping terms, and the shipping time frame. The purchase order then is transmitted back through the enterprise application 502 to the supplier.

In this example, the distribution module 616 uses the exchange information to determine how the packaging is to be supplied from the supplier to the buyer. The distribution module 616 determines how the packaging is to be shipped to the buyer and how the packaging is to be loaded on the shipment vehicle. The distribution module 616 generates this distribution information to the supplier via the enterprise application 502.

The supplier ships the packaging to the buyer according to the terms of the purchase order, the contract, and the distribution information that was generated by the distribution module 616. The supplier then transmits an invoice through the enterprise application 502 to the exchange application 112C. Exchange information is captured from the invoice and used by the relationship management module 612, the inventory management module 614, and the procurement module 404.

The exchange application 112C passes the invoice to the buyer via the enterprise application 502. In addition, in some embodiments, the procurement module 404 generates a flag to the buyer to pay the invoice.

The buyer then can generate quality of service comments through the enterprise application 502 to the exchange application 112C. The quality of service comments will be used by the relationship management module 612 and transmitted to the quality module 604 via the enterprise application 502.

In this example, the inventory management module 614 monitors the exchange information to identify the type and quantity of the packaging being shipped from the selected supplier to the buyer. The inventory management module 614 monitors and tracks where the packaging is located from the time that it resides with the selected supplier (in the supplier's planing system, in work in progress (WIP), and in inventory), through the shipping process, and to the time that it resides with the buyer.

The supply module 602 tracks supplier metrics, including whether the packaging is delivered on time and at the contracted price. The supply module 602 operates with the quality module 604 to evaluate the packaging, identify and track defects in the packaging, and evaluate causes and resolutions for the defects.

Referring still to FIG. 6, in another example, a user of the user computer 106 connects to the specification application 110C via a connection. In this example, the user connects to the specification application 110C directly. It will be appreciated that in other embodiments, the user may connect to the specification application 110C through the enterprise application 502, the source application 504, or a combination of the enterprise application and the source application.

The user operates in the specification application 110C to create a specification for a package and to create a full design for a product. In this example, the user creates a box in which a cake mix will be placed.

The user creates the specification for the box using the specification management module 302 and the specification application 110C. The specification management module 302 manages the user's entry and modification of the specification for the box. The user enters the dimensions of the components of the box, the type of material to be used for the box, and the type of adhesive and printing that will be used for the box. The user uses the design module 304 to design the full product for the box.

The user uses the design module 304 to import images that will be placed on the box. After the specification for the box is fully created, and a design prototype of the box is manufactured, a full 3D image of the box will be created and stored using the design module 304.

Further, the design module 304 is used to generate drawings of the box, including the dimensions of each component of the box. In other examples, CAD/CAM drawings and other technical or graphical drawings of the box are imported using the design module 304.

The assembly module 606 is used to create the procedures in which the box will be manufactured and assembled. The assembly procedures include the manufacturing of the box, the process in which the box is fully formed, and the process in which an adhesive is applied to portions of the box. The assembly module 606 also may be used to create procedures for shipping the boxes or setting up the packaging at a location of consumption.

The specification, images, and procedures are stored in the database 204 (see FIG. 2). Following their storage, the user changes the specifications for the box. The change management module 608 determines that a change has been made to the specification, archives the original specification, and stores the change, the date of the change, and the identification of the user that made the change. In other examples, more or less data identifying the change may be stored.

The user uses the report module 306 to generate a report of the specification information for the product. The user generates a report identifying any specifications for any boxes used for cake mixes sold by the user's company. The user also generates information for the specific product information, including the specification and the drawings.

It will be appreciated that the user may use the specification application 110C and its modules to create a specification for a bag in which the actual cake mix will be placed. Moreover, the user may use the specification application 110C to create specifications for boxes or other packaging in which the complete cake mix product, including the bag with the cake mix and the box in which the bag has been placed and sealed is shipped.

In another example, the user of the user computer 106 is a buyer, and the user of the user computer 108 is a supplier. The buyer and the supplier connect to the SES 104C via an IP connection.

In this example, the specifications for a chemical have been created. In addition, information for profiles of supplier companies, brands, products, and chemicals have been generated by a variety of suppliers to the SES 104C and processed by the SES.

In this example, the buyer desires to procure the chemical, and the supplier desires to supply the chemical. The buyer enters a-search criteria in the search engine of the SES 104C. In this example, the search criteria comprises companies that have revenues greater than $5 million per year. The search engine searches the content in the SES 104C and returns a list of items meeting the search criteria.

The buyer screens through the profiles and/or other information generated by the SES 104C and designates one or more suppliers to which an RFQ and an RFP will be sent. The buyer then generates an RFQ and an RFP to the designated suppliers.

The designated suppliers receive the RFQ/RFP and respond to the buyer with a supply proposal. Like the RFQ/RFP, the supply proposal is generated through the SES 104C from the designated suppliers to the buyer. During this transmission, the SES 104C captures content from the RFQ, the RFP, and the supply proposals and saves the content in its database.

After the supply proposals are generated to the buyer, the buyer reviews the supply proposals to select one of the designated suppliers. In this example, the buyer selects the user of the user computer 108 as its supplier.

In another example, the user of the user computer 106 is a buyer and connects to the specification application 110C over an internet connection using a web browser. The buyer uses the specification application 110C to generate specifications for an input, such as packaging. The buyer desires to procure packaging meeting the requirements of its specification. The buyer selects the source application 504 to access the exchange application 112C.

From the exchange application 112C, the buyer enters information into templates for the RFQ and the RFP. The buyer selects an option to attach specifications for the packaging to the RFQ/RFP. The exchange application 112C communicates with the source application 504 to pull the specifications from the specification application 110C. The buyer then sends the RFQ/RFP with the attached specifications to designated suppliers.

Still referring to FIG. 6, in another example, the user of the user computer 106 is a buyer. The buyer connects to the exchange application 112C via an intranet connection over a virtual private network (VPN) using a web browser. In this example, the buyer is a subscriber of the specification application 110C and desires to transmit an RFQ and an RFP to designated suppliers. The buyer enters content into an RFQ template and an RFP template to generate the RFQ/RFP. The buyer desires to attach a set of specifications that reside with the specification application 110C. The buyer selects an option in the exchange application 112C to attach the specification for the packaging. The exchange application 112C operates with the source application 504 to pull the specifications from the specification application 110C. The source application 504 pulls the specification to the exchange application 112C, and the exchange application attaches the specification to the RFQ/RFP.

The buyer then transmits the RFQ/RFP with the attached specifications to designated suppliers. One or more of the designated suppliers then respond to the RFQ/RFP with a supply proposal.

In still another example, the user of the user computer 106 is a buyer. The buyer connects to the exchange application 112C to generate an RFQ and an RFP. In this example, the buyer is not a subscriber to the specification application 110C. Therefore, the buyer does not have the ability to generate specifications or to attach specifications from the specification application 110C to the RFQ/RFP to procure raw materials for a process. The buyer enters content into templates for the RFQ and the RFP. In this example, the exchange application 112C has an associated database in which the exchange application stores the content entered by the buyer.

The buyer transmits the RFQ/RFP to designated suppliers. One or more of the designated suppliers respond to the RFQ/RFP with a supply proposal. The supply proposals are transmitted through the exchange application 112C to the buyer. While the supply proposals are passing through the exchange application 112C, the exchange application captures content from the supply proposals and stores the content in the database. In other examples, the exchange application 112C stores content entered by the buyer into the RFQ/RFP templates or content from the supply proposals, but not both.

In another example, the user of the user computer 106 is a buyer. Previously, the buyer has accessed the exchange application 112C and has entered content into templates for the RFQ and the RFP. That content has been stored in a database associated with the exchange application 112C.

The buyer again accesses the exchange application 112C to generate another RFQ and another RFP. The buyer requests access to the prior RFQ/RFP and the associated content. The exchange application 112C retrieves from the associated database, the RFQ, the RFP, and the associated content. The buyer modifies the content and generates a new RFQ/RFP. The exchange application 112C saves the new RFQ/RFP with the new content in the database.

The buyer transmits the new RFQ/RFP to designated suppliers. The designated suppliers respond to the buyer with supply proposals.

In yet another example, the user of the user computer 106 is a buyer. The buyer accesses the exchange application 112C via the enterprise application 502. The buyer desires to send an RFQ and an RFP to designated suppliers. The buyer accesses templates through the exchange application 112C and enters content into an RFQ template and an RFP template.

The buyer selects an option to attach a specification document to the RFQ/RFP. The exchange application 112C communicates with the source application 504, and the source application pulls the specification from the specification application 110C to the exchange application. The specification document is attached to the RFQ/RFP.

The buyer transmits the RFQ/RFP with the attached specification document to designated suppliers. In this example, the RFQ/RFP is transmitted out through the enterprise application 502 to the designated suppliers. In other examples, the RFQ/RFP is transmitted out of the SES 104C without going through the enterprise application 502.

The enterprise application 502 communicates with the buyer's user application on the user computer 106. The enterprise application 502 transmits updated specification information and/or updated exchange information to the user application on the buyer's user computer 106. This update occurs in real time.

Referring still to FIG. 6 in another example, the user of the user computer 106 is a buyer. The buyer connects directly to the source application 504 via a connection. The buyer uses the source application 504 as a tool to generate an RFQ and an RFP. The source application 504 accesses templates for the RFQ and the RFP. The buyer enters content into the RFQ/RFP and transmits the RFQ/RFP to designated suppliers.

In this example, the source application 504 transmits the content to the specification application 110C for storage. In other examples, the content is not stored by the SES 104C. In still other examples, some content is transmitted to the exchange application 112C for storage in an associated database. In still other examples, some content is transmitted to each of the specification application 110C and the exchange application 112C for storage in separate associated databases.

In another example, the user of the user computer 106 is a buyer. The buyer connects to the source application 504 through the enterprise application 502.

The source application 504 accesses templates for an RFQ and an RFP. The buyer enters content into the RFQ/RFP and transmits the RFQ/RFP to designated suppliers. In this example, the RFQ/RFP is transmitted to the designated suppliers through the enterprise application 502. The designated suppliers respond to the RFQ/RFP with supply proposals that are transmitted to the buyer via the enterprise application 502.

In another example, the user of the user computer 106 is a buyer. The buyer connects to the source application 504 via the enterprise application 502. The buyer desires to transmit an RFQ and an RFP to designated suppliers. The buyer accesses the RFQ template and the RFP template. The source application 504 communicates with the buyer's user application on the buyer's user computer 106. The source application 504 pulls content from the user application, such as annual quantities of packaging required by the buyer and enters the content into the RFQ/RFP. Other content also may be pulled by the source application 504 from the user applications for use with the RFQ/RFP. The buyer manually enters additional content into the templates for the RFQ and the RFP.

In this example, the source application 504 does not communicate with the specification application 11C or the exchange application 112C. However, in other applications the source application 504 may pull a specification or other specification information from the specification application 112C so that the specification or other specification information may be attached to the RFQ/RFP. In addition, in other applications, the source application 504 may communicate with the exchange application 112C to obtain forecasted purchased quantities or other order quantities. It will be appreciated that this content may be stored in a database associated with the specification application 11C and a database associated with the exchange application 112C, a common database accessed by both the specification application and the exchange application, a database that may be accessed only by the specification application, or a database that may be accessed only by the exchange application.

Once the RFQ/RFP is complete, the buyer transmits the RFQ/RFP to designated suppliers. One or more of the designated suppliers respond to the RFQ/RFP with a supply proposal. The supply proposal is transmitted to the buyer. In this example, the enterprise application 502 communicates with the buyer's user application on the buyer's computer to update the user application with content and to pull content from the user application to update the content stored in the SES 104C.

In yet another example, the user of the user computer 108 is a wholesaler. The wholesaler aggregates its finished products in a single location with finished product specifications. Among the specifications is a popcorn product specification that specifies the number of popcorn product bags in a popcorn product box. Each popcorn product bag has an identification code. In addition, the box containing the popcorn product bags has a unique identification code. The specifications for the popcorn product bag and the popcorn product box are stored with the specification application 110C.

A first retailer connects to the exchange application 112C to purchase twenty-five boxes of the popcorn product. The first retailer enters the identification number of the popcorn product box as a search criteria in a search engine of the exchange application 112C. The exchange application 112C operates with the source application 504 to import the specification for the popcorn product box from the specification application 110C to the exchange application. By providing this specification, the first retailer can confirm that the identification number entered by the first retailer correlates to the popcorn product box and not to the popcorn product bag.

The first retailer selects an option from the exchange application 112C to create a purchase order. In this example, the purchase order is similar to an RFQ. However, the purchase order is more limited.

The first retailer enters the number of boxes to be ordered and its company identification information. The first retailer then transmits the purchase order to the wholesaler.

A second retailer connects to the exchange application 112C. The second retailer steps through the same process identified above to order 20 boxes of the popcorn product. The second retailer enters the requisite information into a purchase order and transmits the purchase order to the wholesaler.

The exchange application 112C operates with the procurement module 404, the inventory management module 614, and the distribution module 616 to save content from the purchase orders and to determine how the popcorn product boxes will be shipped to the first and second retailers. In this example, the first and second retailers are in the same portion of the same city. The exchange application 112C determines that a single truck can deliver the popcorn product boxes to both retailers. In addition, the exchange application 112C determines how the truck will be loaded with the popcorn product boxes. In this example, the wholesaler ships its products in trucks owned by the wholesaler. However, in other examples, the exchange application 112C can determine a shipping company to deliver the popcorn product boxes.

In still another example, multiple wholesalers aggregate their products using the SES 104C. Each wholesaler has a specification for each product, and each product has a unique identification number. Each wholesaler uses a catalog feature for their products, and their associated specifications, in which an image of each product with its associated identification number are depicted.

The user of the user computer 106 is a retailer in this example. The retailer connects to the exchange application 112C. The retailer opens a template for a purchase order. The retailer enters several identification numbers that correspond to finished products for a first wholesaler. The retailer also enters its company information and pricing in that purchase order. The retailer then transmits the first purchase order to the first wholesaler.

While the retailer is connected to the exchange application 112C, the retailer opens a second template for a second purchase order. The retailer enters identification numbers for finished products for the second wholesaler. The retailer enters its company information and transmits the second purchase order through the exchange application 112C to the second wholesaler.

The exchange application 112C, using the distribution module 616, determines that the goods ordered by the retailer can be shipped on a single truck. The distribution module 616 generates a communication to the first wholesaler and the second wholesaler identifying a third party shipping company that can pick up and deliver the goods ordered by the retailer. The exchange application 112C saves content from the first and second purchase orders and the generated communication to an associated database.

In another example, finished product specifications are held in the specification application 110C, and they can be configured to provide shipping information for each finished product. This information includes the number of units per case, the number of cases per layer on a pallet, the number of layers per pallet, the number of cases per pallet, the outside case dimensions (case cube), the complete pallet dimensions (pallet cube), the weight per case, and the total weight of a pallet. This information is contained in the specification application 110C in the same terminology and format so that several different products from several different companies can be combined on a shipping vehicle, such as a truck, a rail car, a crate, or another vehicle, in a manner to optimize the shipping vehicle's space without over weighting. Today this information is inconsistent and many trucks are under filled or over filled, in which case two trucks are required, or are over weighted generating fines to the trucking company. The specification application 110C when applied properly will eliminate this problem and significantly reduce costs for shipping.

It will be appreciated that other examples can be identified to demonstrate how the SES 104C of FIG. 6 can be operated. The users of the user computers 106 and 108 can use the specification application 110C and the exchange application 112C in a variety of ways to generate specifications for packaging and to source and procure packaging.

FIG. 7 depicts an exemplary embodiment of a user interface 202A. The user interface 202A generates screens for a search engine 702, search results 704, a logon 706, templates 708, images 710, and drawings 712. Another user interface may be used.

The search engine 702 enables a user to search content by entering a search criteria. A user can search by a user, a product, a company, a supplier, a component, a specification parameter, a client, a brand, a code, a component type, and a manufacturing site. The results of the search criteria are generated in another screen. In some embodiments, the results can be selected to further view additional detail of the search results.

The search results 704 are generated to a user after the search criteria has been entered and executed. With a brand search, products and contact information associated with each brand are generated to a user. With a company search, a list of companies, products associated with that company, and company profiles are generated to a user. With a product by company search, the product, packaging for the product, product code, and product details are generated to a user. With a manufacturing site search, the site, the company, and the products manufactured at the site are generated to the user. With a supplier search, the supplier, the location of the supplier, the components made by the supplier, and the manufacturing sites in which those components are used are generated to the user. With a component code search, the component, the details of the component, the specifications for the component, and the manufacturing site where the component is used are generated to the user.

In addition to those results identified above, a user may select a link on a search result screen to view additional specification information. For example, a user may view affiliated products, view a list of groups owned by a company, view specification details for a particular component, and view a list of users associated with a company.

The search results 704 also can enable a user to select a product code to view how a product is supplied or to select a component to view its details. All products associated with a brand can be viewed, including the product details. From an all product search, the product code and how the product is supplied can be viewed. From a search of all pending products, the pending products and their components can be viewed and approved. From a search of a specific product code, the information on how the product is supplied can be viewed. From a search of a specific product code using the UPC code, the product, the product code, and the specifications for the product can be viewed. Pending/draft items, retired items, and historical archived items can be viewed using a draft, current, retired, and archived search, respectively.

The logon screen 706 is generated to enable a user with a valid password to enter the system. A company name, a user name, and a password must be entered, and access to various specification information and/or exchange information is granted based upon the company name, the user name, and the password.

Templates 708 are generated for use by a user so that all users use common standard terminology in a standard format and so that users provide specification information or exchange information required to supply or procure packaging. In addition, templates 708 are used so that the management system 102 can locate specification information and/or exchange information in communications to and from users.

The user interface 202A also generates images, such as still images, 3D images, and rotating images. The images 710 may be created using the management system 102 or imported into the management system.

The drawings 712 depict packaging or components of packaging. The drawings 712 may be generated using the management system 102 or may be imported into the management system. The drawings 712 depict various levels of the specifications and steps to follow to assemble packaging.

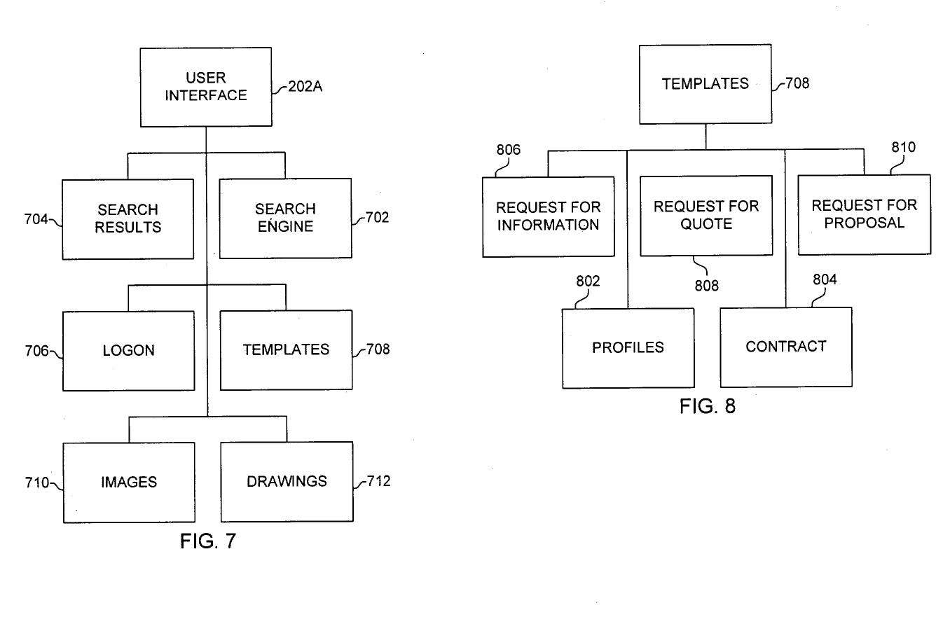

FIG. 8 depicts an exemplary embodiment of templates that may be used in conjunction with the management system 102. The templates 708 of FIG. 8 comprise profiles 802, a contract 804, an RFI 806, an RFQ 808, and an RFP 810. Other templates may be used.

The profiles 802 are used to enter specification information and exchange information in a format that can be readily accessed and used by the management system 102. The profiles 802 also ensure that all the information needed by the management system 102 is entered by a user.

The profiles 802 may include a brand profile, a site profile, a company profile, and a profile specifying users that can be assigned to a particular group for a particular company. In addition, the profiles 802 may be used to identify information for a supplier of a particular component type, a product, including a product description, and a component type. Additional profiles include a pending product, a component specification, a pending, draft, or retired component specification, a pending, draft, or retired product, or historical specifications. Other profiles 802 include shipping instructions, print card images, companies affiliated with products and components, and export specifications.

The contract 804 enables the management system 102 to monitor and track exchange information for particular transactions. The contract 804 will include a package identification, quantity of the packaging ordered, the cost for the ordered packaging, and shipping requirements.

The RFI 806 generates questions to potential suppliers to determine if a supplier can be a qualified supplier and to determine if a supplier can meet a buyer's needs. The RFI 806 includes general company questions, such as the company name, the address, the company description and history, company products, and a website location.

In addition, corporate strategy questions are presented. The corporate strategy questions may include a mission statement, a long term business plan, strategic management plans, safety policies and safety ratings, environmental positions, and an identification of diversity programs.

Financial information also can be generated in the RFI 806. Financial information may include total sales and net income for a past number of years, capital expenditures, whether goods are exported outside the country, percent of sales that are exports, and insurance coverage.

The RFI 806 also may include quality issues. Such quality issues may require the company to describe its quality control program, its sanitation program, the work-in-process raw material certification procedures, and the quality processes required from its suppliers.

The RFI 806 may include sales information. The sales information may comprise the company's long term sales growth strategy, the company's market segments, key industry trends, and the company's sustainable competitive advantages.

Manufacturing information may be required by the RFI 806. Manufacturing information may include facility locations, special manufacturing capabilities, ERP or MRP manufacturing systems, and which, if any, facility locations are International Standard Organization (ISO) certified.

The RFI 806 may require an identification of miscellaneous items and support services. These items and services may include describing buyer support strategies and programs, returns and claims programs, cost reduction policies and programs, and a description of research and development capabilities, histories, and expenditures.

The RFQ 808 identifies the information for the particular packaging or product required by a buyer to obtain a quote from suppliers. Typically, the RFQ 808 may include product information, material information, finishing information, printing information, forecasted annual demand, and order and release practices for each item. The RFQ 808 also may include buyer name, the product specification, the quantity of the product needed, delivery/shipping requirements, and an expiration date for the RFQ.

The RFP 810 identifies the specifications of a package to be procured and questions to be answered by a supplier so that a buyer can evaluate the supplier. The exchange information provided in the RFP 810 is used by the management system 102 to monitor and track transactions and to monitor and track quality of service.

The RFP 810 may include general location questions. These general location questions may request the supplier's company name, the company address, countries in which the company operates, the ownership structure, and the location of products.

The RFP 810 also may require location statistics. Location statistics may include total sales and total volume for each of a past number of years, expected output for the current year, estimated maximum annual capacity, capital budget and actual capital expenditures for a past number of years, raw material sources including supplier names and locations, and the location of a back-up plant, if any.

Quality issues also may be included in the RFP 810. These quality issues may require a supplier to describe its quality control program, the sanitization and pesticide program, the quality processes required by its suppliers, and the supplier's work-in-process raw material certification procedures.

Sales information and support services identifications may be included in the RFP 810. These may require an identification of the market segments served by the supplier and support services provided by the supplier to reduce time to market for products or packaging with each of the RFI 806, the RFQ 808, and the RFP 810. Other information, less information, or more information may be required. Additionally, one or more of the RFI 806, the RFQ 808, and the RFP 810 may be combined into one or two documents, expanded into more documents, or eliminated.

Those skilled in the art will appreciate the variations from the specific embodiments disclosed above are contemplated by the invention. The invention should not be restricted to the above embodiments, but should be measured by the following claims.

What is claimed is:

1. A system for managing an input comprising:
a specification application comprising a data warehouse having a specification template and configured to generate the specification template with standard terminology; and
a specification management module comprising an input definition of the input and configured to receive content to create a specification for the input, to manage storage of the content, and to manage real-time access to the specification.

2. The system of claim 1 further comprising a design module configured to use at least one member of a group comprising a design predictor configured to generate a recommended size and a recommended type of the input and a performance predictor configured to generate a recommended type of a material used with the input when the input is assembled.

3. The system of claim 1 further comprising a design module comprising a design tool configured to perform real-time collaboration to design the input.

4. The system of claim 3 wherein the design module further is configured to design a product comprising the input.

5. The system of claim 3 wherein the design module further is configured to generate for the input at least one member of a group comprising a drawing, an image, and a graphic.

6. The system of claim 1 further comprising a report module configured to receive a query, to organize the content according to the query, and to output the organized content.

7. The system of claim 1 further comprising a supply module configured to track performance metrics for a user and to generate a quality of service rating for the user using the performance metrics.

8. The system of claim 1 further comprising a quality module configured to track a defect of the input.

9. The system of claim 1 further comprising a quality module configured to perform at least one member of a group comprising identifying a proper assembly of the input, evaluating the assembly for a defect, identifying a cause for the defect, and identifying an action to correct the defect.

10. The system of claim 1 further comprising an assembly module configured to generate a procedure to assemble the input.

11. The system of claim 1 further comprising an assembly module configure to generate an identification of a proper material used to assemble the input.

12. The system of claim 1 further comprising a change management module configured to archive a change to the specification.

13. The system of claim 1 further comprising a content module configured to change an output of the content generated to a user interface.

14. The system of claim 1 further comprising a search engine configured to search content using a search criteria and to generate a search result.

15. The system of claim 1 wherein the search criteria comprises at least one member of a group comprising a user, a product, a company, a component, a specification parameter, a client, a brand, a code, a component type, and a manufacturing site.

16. The system of claim 1 wherein the specification application further is configured to import at least one member of a group comprising an image, a drawing, and a video.

17. The system of claim 1 further comprising a user computer configured to communicate with the specification application.

18. The system of claim 17 wherein the user computer comprises a member of a group comprising an enterprise requirement planning module and a materials requirement planning module.

19. The system of claim 17 wherein the specification application is configured to automatically import content from a user application for updating the content stored by the specification application.

20. The system of claim 17 wherein the specification application is configured to communicate with a user application and to automatically update content to the user application when a status of the specification is approved.

21. The system of claim 1 wherein the input comprises at least one member of a group comprising a package, a product, a product identification, a raw material, an ingredient, and a service.

22. A system for managing an input comprising:
a specification management module comprising an input definition of the item and configured to receive content to create a specification for the input, to manage storage of the content, and to manage real-time access to the specification; and
a design module comprising a design tool configured to perform real-time collaboration to design the input.

23. The system of claim 22 further comprising a design module configured to use at least one member of a group comprising a design predictor configured to generate a recommended size and a recommended type of the input and a performance predictor configured to generate a recommended type of a material used with the input when the input is assembled.

24. A method for managing an input comprising: ? connecting to a specification application;
generating from the specification application a template having a standard format and standard terminology for a specification for the input;
receiving content for the specification and generating from the specification application the specification for the input using the content.

25. The method of claim 24 further comprising receiving the content through an enterprise system at the specification application.

26. The method of claim 24 further comprising receiving the content through a sourcing application at the specification application.

27. The method of claim 24 further comprising communicating with a user application to import content to the specification application.

28. The method of claim 24 further comprising communicating with a user application to automatically update content from the specification application to the user application.

29. The method of claim 24 further comprising archiving a change to the specification.

30. The method of claim 24 further comprising saving content in a database.

31. The method of claim 24 wherein the input comprises a member of a group comprising a package, a product, a product identification, a raw material, an ingredient, and a service.
